(19) United States
(12) Patent Application Publication
(10) Pub. No.: US 2018/0316964 A1
(43) Pub. Date: Nov. 1, 2018

(54) SIMULTANEOUS LIVE VIDEO AMONGST MULTIPLE USERS FOR DISCOVERY AND SHARING OF INFORMATION

(71) Applicant: K, Online Inc, Bellevue, WA (US)

(72) Inventors: Kevin M. Dillon, Bellevue, WA (US); Cooper Crosby, Seattle, WA (US); Andri Kurshyn, Bellevue, WA (US)

(21) Appl. No.: 15/967,300

(22) Filed: Apr. 30, 2018

Related U.S. Application Data
(60) Provisional application No. 62/491,956, filed on Apr. 28, 2017.

(51) Int. Cl. H04N 21/431; G06Q 10/06; H04L 12/18; G06F 3/0481; G06F 3/0482; H04L 29/06; H04L 12/58

(52) U.S. Cl. CPC H04N 21/4316; G06Q 10/06311; H04L 12/1895; H04L 51/046; G06F 3/0482; H04L 65/403; G06F 3/04817

(57) ABSTRACT

Systems, devices, and methods for simultaneous live video amongst multiple users for discovery and sharing of information are disclosed herein. In some embodiments multiple users participate in live face to face video communication on a mobile device to assist in planning events and activities. Users share local listing data, movies, events, concerts, restaurants, coupons, and live video programming like movies and concerts. Users may also share, in real-time what they are interested in with other users and create an itinerary of the plan that all the users agree on. The itinerary may then be shared with each user and updated in real-time.

### CROSS-REFERENCE

This application claims the benefit of U.S. Provisional Application No. 62/491,956, filed Apr. 28, 2017, which application is incorporated herein by reference.

### BACKGROUND

Communication and planning amongst multiple people on hand held devices, such as mobile phones and tables is a cumbersome experience. Existing video chat systems do not allow for layering of planning data on top of a video chat. Instead, users switch between various types of content and applications, to separately chat and research planning data. This interrupts the chat to conduct research and vise-versa and leads to a less than ideal solution.

### SUMMARY

This disclosure is directed to using simultaneous live video amongst multiple users to facilitate the discovery and sharing of information. Overlaying rich media content on top of live video chat video amongst multiple people.

The advantages of the systems, devices, and methods disclosed herein are that multiple users can participate in live face to face video communication on a mobile device to assist in planning events and activities. Users are able to share local planning data such as, movies, events, concerts, restaurants, coupons, and live video programming. Users can share what they are interested in with other users simultaneously and in real-time to create an itinerary of a plan that all the users agree on. The itinerary is shared with each user and updated in real-time during the planning process.

Users interact with one another through the system by discovering and selecting things to do in order to make plans, all without leaving the video chat interface. In some embodiments, this is accomplished by bringing planning data together and layering it on top of the video chat user interface. Planning data may include data that is used to support the planning effort, such as local listing data, movies, events, concerts, restaurants, coupons, and live video programming 544 that is layered on top of video chat.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a method of overlaying planning data on a video chat, according to one or more embodiments herein.

FIG. 2 illustrates process flow among elements of a video chat and planning system, according to one or more embodiments herein.

FIG. 3 illustrates data flow and connections among elements of a video chat and planning system, according to one or more embodiments herein.

FIG. 4 illustrates a multi-user video chat on a user device, according to one or more embodiments herein.

FIG. 5 illustrates the overlay of planning data search results on a video chat on a user device, according to one or more embodiments herein.

FIG. 6 illustrates the overlay of planning data selection on a video chat on a user device, according to one or more embodiments herein.

FIG. 7 illustrates the overlay of shared planning data on a video chat on a user device, according to one or more embodiments herein.

FIG. 8 illustrates the overlay of a plan on a video chat on a user device, according to one or more embodiments herein.

FIG. 9 illustrates the overlay of planning data search results on a video chat on a user device, according to one or more embodiments herein.

FIG. 10 illustrates the overlay of video planning data on a video chat on a user device, according to one or more embodiments herein.

### DETAILED DESCRIPTION

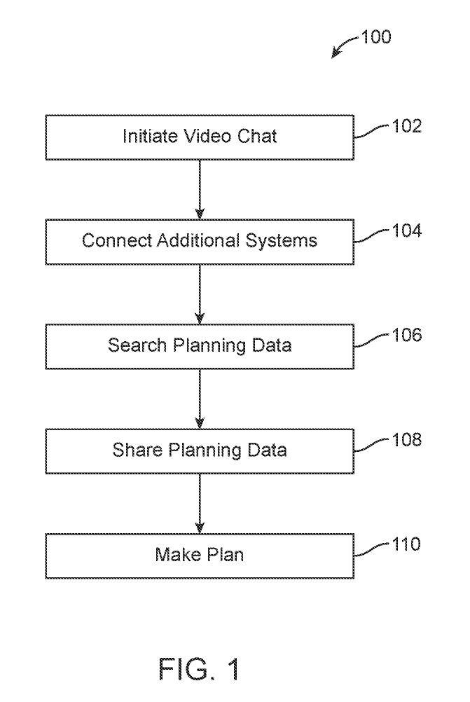

FIG. 1 depicts a method 100 of overlaying planning data on a video chat to make a plan, according to one or more embodiments herein. The method allows users to interact with one another by discovering and selecting things to do in order to make plans all within a video chat interface. This is accomplished by bringing planning data together and layering it on top of the video chat user interface. Planning data may include data that is used to support the planning effort, including local listing data, movies, events, concerts, restaurants, coupons, live video programming like movies or concerts. The layering of planning data on top of video chat in order to make an itinerary of events, known as a plan with a user or multiple users is the invention. Existing video chat apps don't allow for layering of planning data on top of video chat, they have to switch from one app to another to view event planning data.

At block 102 a request to initiate a video chat is sent by a first user device to a second or more user devices. The second or more user devices may confirm the request to initiate a video chat, after which a video chat between the users and their devices begins.

At block 104 additional users and devices may be connected to the video chat. Through the user devices, additional users and their respective devices may be invited to the video chat. The newly-added users have access to the history of the video chat—any text chats, the contents of plans created as part of the video chat (whether or not the newly-added member of the video chat is a plan participant), a record of any videos that the members of the video chat watched, and a record of any users who were added to or removed from the video chat.

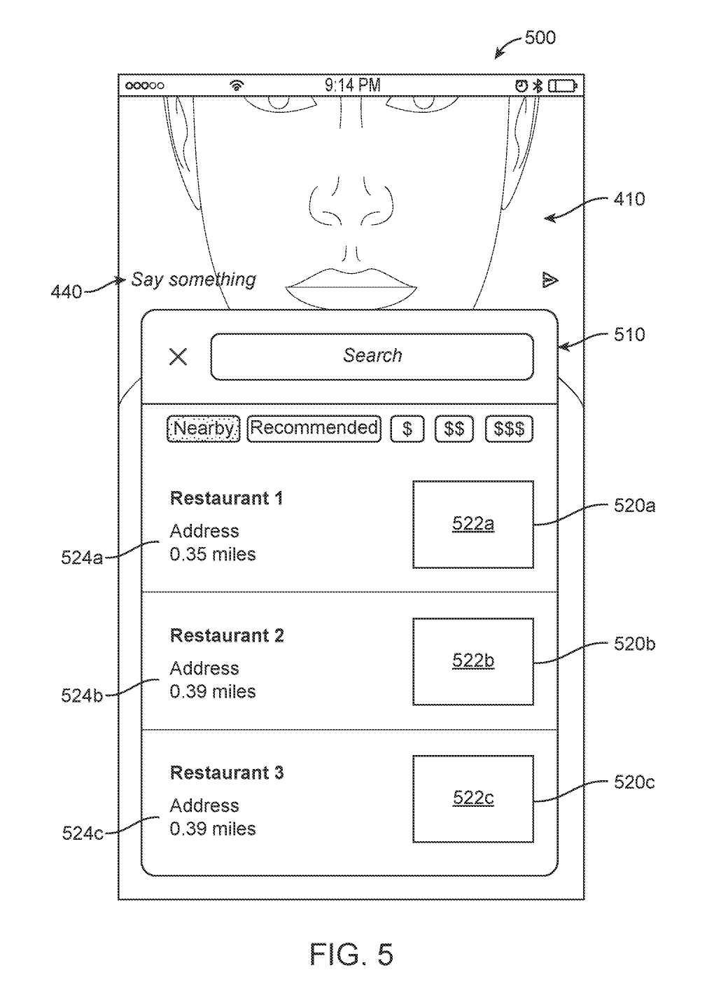

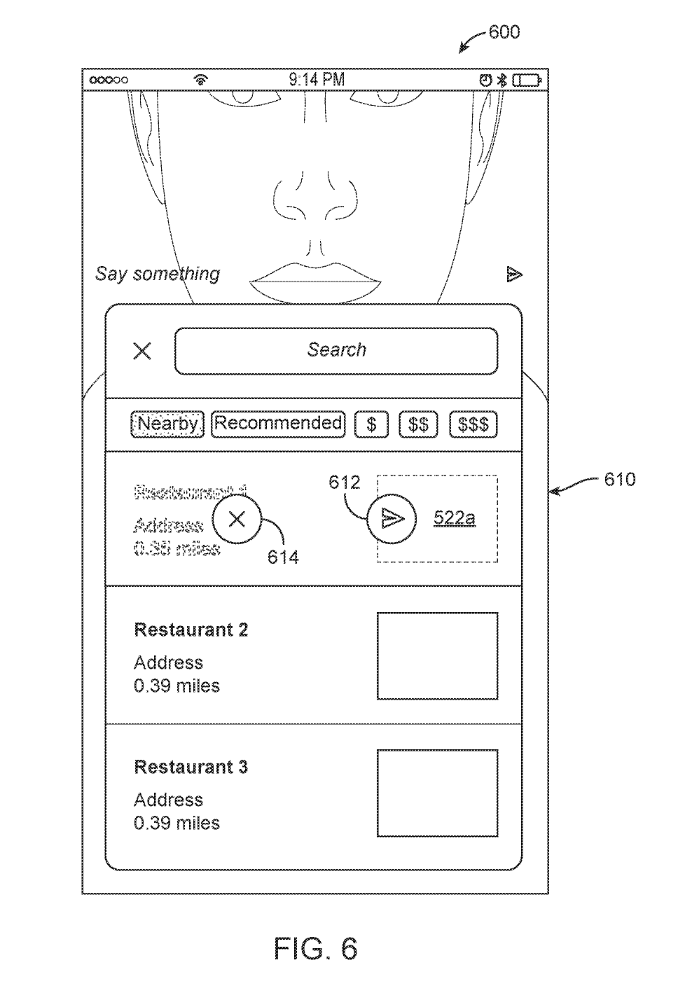

At block 106 planning data is searched. Planning data search results, such as local listing data, movies, events, concerts, restaurants, coupons, and live video programming is overlaid over the top of the video chat, as shown and described with respect to FIG. 5. Search results may be displayed on a single device, for example, on the device on which the search was initiated, as shown and described with respect to FIG. 6, or may be shared with one or more other devices connected to the video chat. In some embodiments, only selected search results are shared with the other devices connected to the video chat.

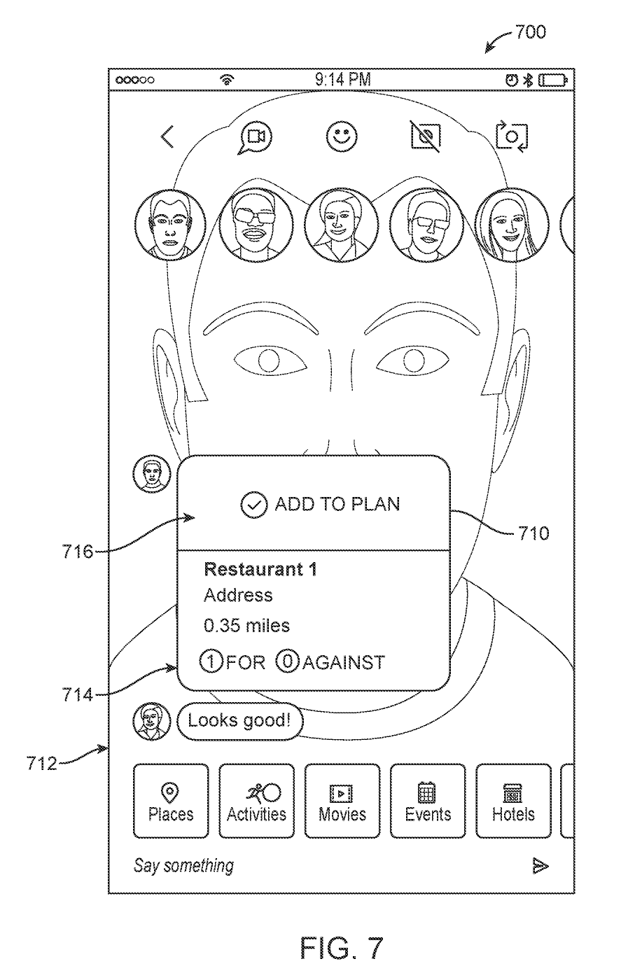

At block 108 planning data, such as a selected piece of planning data, from the search results is shared with one or more of the other devices connected to the video chat, for example, as shown and described with respect to FIG. 7.

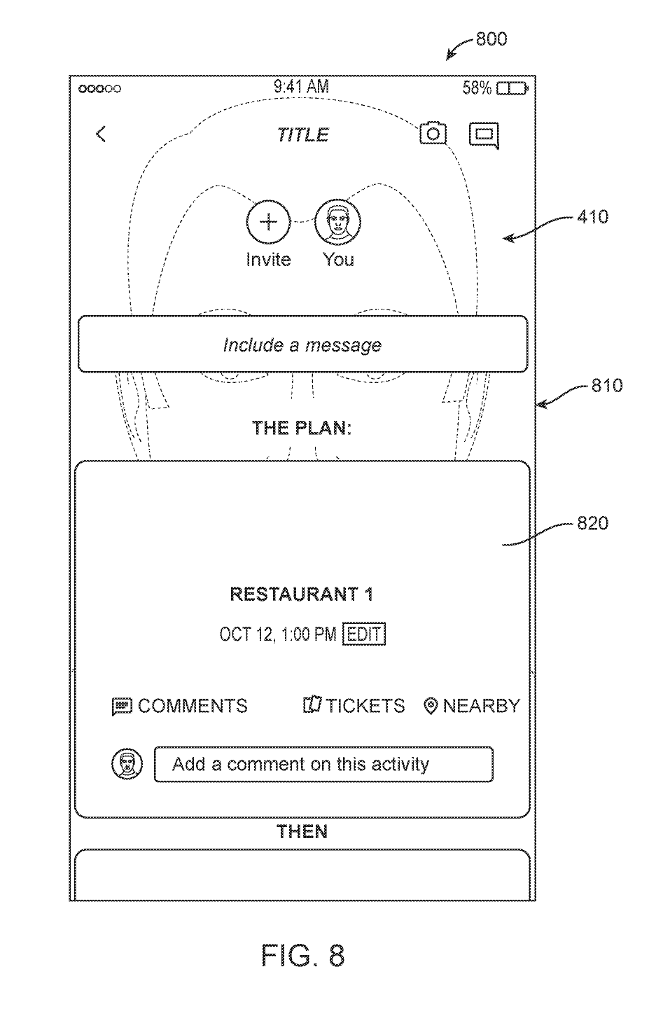

At block 110 the planning data is added to a plan that is overlaid on top of the video chat on one or more of the user devices, for example, as shown and described with respect to FIG. 8.

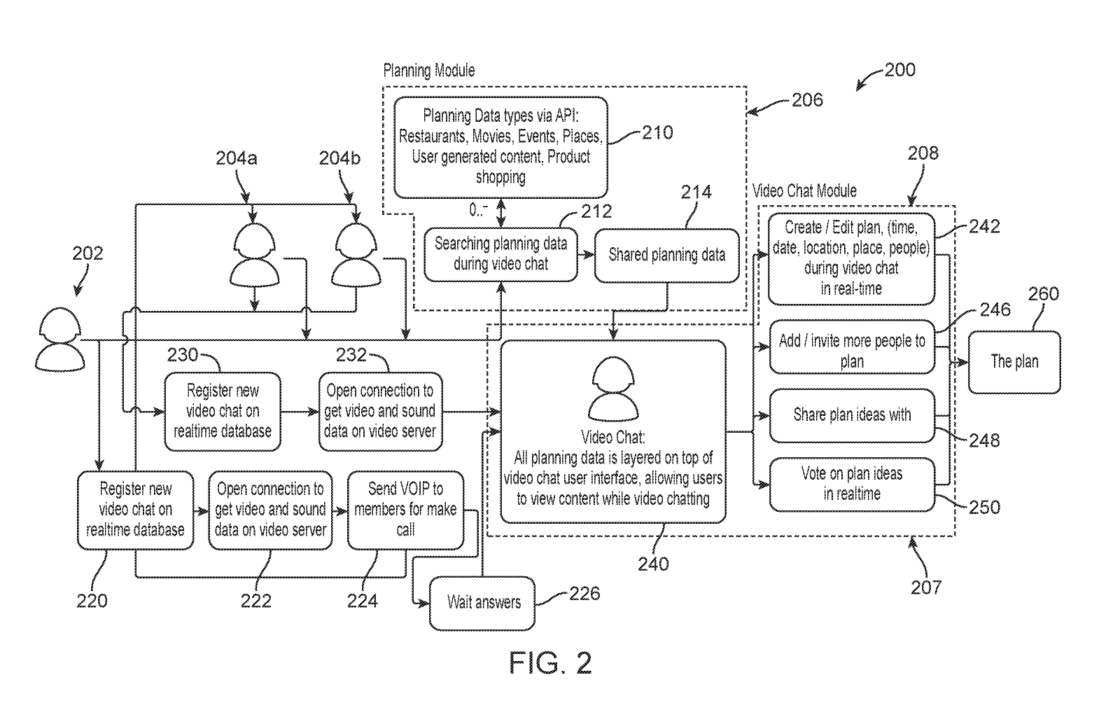

FIG. 2 illustrates process flow among elements of a video chat and planning system 200. User device 202 imitates a video chat, for example as described above with respect to FIG. 1, at block 102. Upon a request to initiate a video chat the device 202 sends requests to other users and their user devices 204a, 204b. Initiation may also include registering a new video chat on a real-time database at block 220. The real-time database may be part of or separate from a video chat module 207. Upon registration in the real-time database, at block 222, a connection is opened to send and receive video and sound data via the video server which may be part of the video chat module 207. Next a VOIP request is sent to invited devices, such as user devices 204a, 204b.

At block 226, the user device 202 that initiated the video chat waits for answers from the user devices 204a, 204b. Upon receiving an answer from the user devices 204a, 204b, at block 230 each respective user device 204 registers a new video chat on the real-time database and then opens a connection to receive video and sound data from the video server of the video chat module 207.

The video chat module 207 in conjunction with the planning module 206, displays the video chat video from each user and also facilitate the gathering and display of the planning data overlaid on the video chat. During the video chat, the user devices 202, 204 search planning data at block 212. The devices 202, 204 access and search planning data via APIs for each respective type of planning data. At block 210, the devices send requests through the API to providers of various types of planning data. The API then returns planning data search results to the user devices for display over the video chat. In some embodiments, the planning module is located on each respective user device. In some embodiments, the planning module is located on a device, such as a server, that is remote from the user devices.

At block 214, shared planning data from an individual user device is transmitted to the video chat module where the information is formatted and prepared for distribution to each of the other user devices 202, 204 that are participating in the video chat.

At block 242, the video chat module includes submodules such as submodule 242 for creating and editing a plan 260 within the video chat in real-time. Submodule 246 receives invitations from current user devices participating in the video chat to potential new user devices and coordinates the addition of these new user devices to the video chat. Submodule 248 facilitates the sharing of plan ideas across the video chat on each user device.

Submodule 250 coordinates the voting for each of the plan ideas and planning data across the user devices. The sub module 250 may receive requests to vote on a particular part of the plan or a particular piece of shared planning data and then receive votes from each of the user devices to accept or reject a particular part of the plan or particular piece of shared planning data. Accepted parts and data are added to or remain part of the plan and rejected parts and data are either removed from the plan, if already part of the plan, or not added to the plan 260.

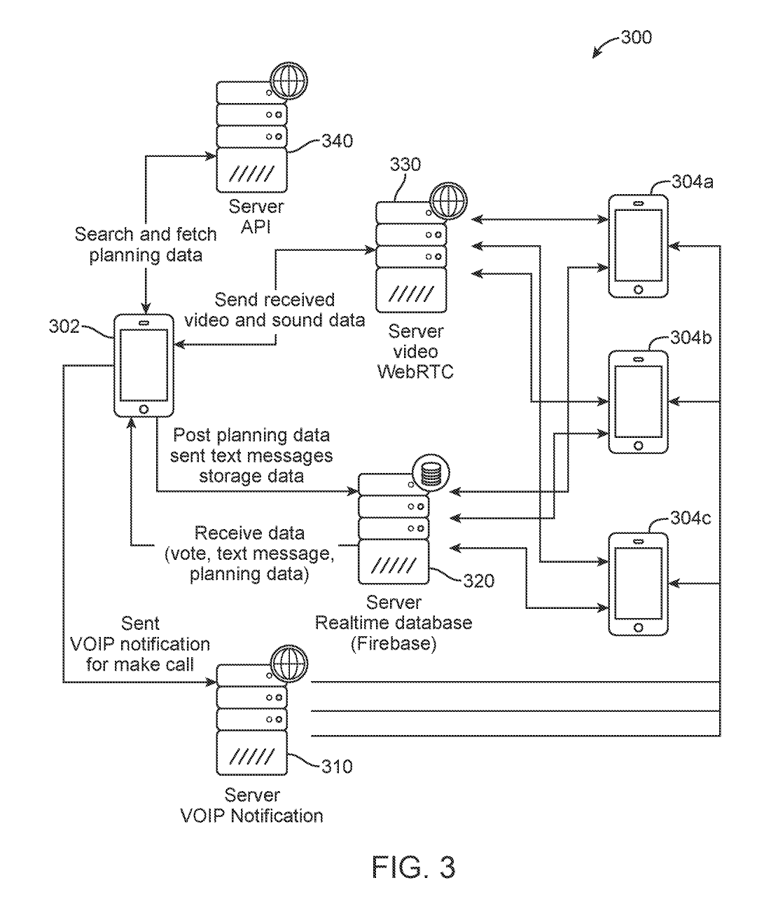

FIG. 3 illustrates data flow and connections among elements of a video chat and planning system 300, according to one or more embodiments herein. System 300 shows the connections between the various user devices 302, 304 and the servers 310, 320, 330, 340. The connections maybe physical electronic connections or communicate paths between the various devices and servers. As shown in FIG. 6, each of the devices is connected to one another through the servers or directly. A direct connection between two or more of the devices 202, 204 does not pass though one of the servers 310, 320, 330, 340 but may pass through other server such as servers and routers on the Internet. Such servers and routers may not be associated with or otherwise under the control of the system 300. A first device such as device 302 may search and fetch planning data through server API of the search server 340.

The real-time database server 320 acts, in part, as a router of information and data between and among is a device 302 Andy user devices 304a, 304b, 304c.

The video server 330 acts, in part, as a router of video and sound data, such as the video and sound associated with the video chat, between and among is a device 302 Andy user devices 304a, 304b, 304c.

The VOIP notification server acts, in part, to coordinate the initiation and confirmation of VOIP information, between and among is a device 302 Andy user devices 304a, 304b, 304c.

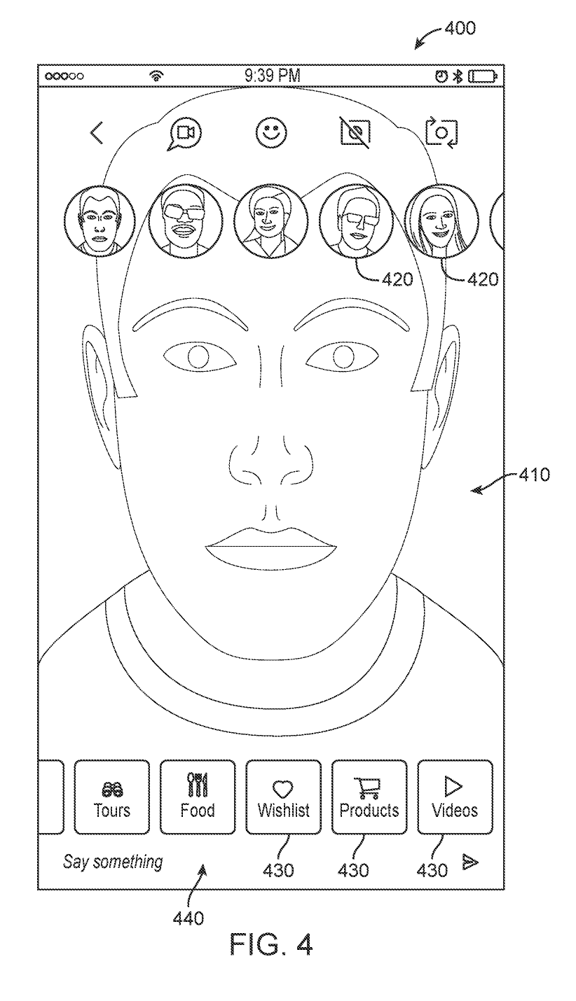

FIG. 4 illustrates a multi-user video chat on a user device 400, according to one or more embodiments herein. The user device 400 and other users devices described herein may be similar to the user devices 202, 204, 302, 304, described above. As shown in FIG. 4, the user device processes the video chat information and displays it on the device's display. For example, video chat video 410 may be video from the device 400, displayed such that a user may see what the device is transmitting to other devices that are part of the video chat. Simultaneously to displaying the video 410 the device 400 overlays the video feeds 420 from one or more other participating devices. In addition, the device 400 may simultaneously overlay text chat 440 and planning data resources 430 over the top of the video chat 410. When the device receives input indicating the selection of a type of planning data to be searched, the device 400 may overlay search data over the video chat.

FIG. 4 may be an opening screen that allows a user to add multiple people to a live video chat, as shown in the user images at the top of the screen. A user is able to select from a menu of different data types to assist in the planning of an event or an activity, for example as shown at the bottom of FIG. 4.

FIG. 5 illustrates the overlay of planning data search results layer 510, including planning data search results 520 on a video chat 410 on a user device 500, according to one or more embodiments herein. During a search the user device sends a request to the search server. The search server searches various sites to gather planning data search results 520 and sends the search results to the user device. The user device displays the search result planning data, on a search result view layer 510 on top of the video view layer. The search result view layer 510 may be a rectangle that partially covers the video view layer. The search result view layer 510 may not fully cover the video view layer 410, because user devices should display the video view layer and search result view layer 510 on the display at the same time. The search results view area may include a list of search results 520. Each search result may include data about the search result. For example, the search results displayed in FIG. 5, include results related to a restaurant search. Accordingly, the search results 520 include data 524 such as the name, address, and distance to each restaurant and an image 522 that is related to the restaurant. The search results data may also include other qualities of the results, such as the type of food served, the relative pricing of the restaurant, etc.

As also shown in FIG. 5, the text chat layer 440 has been moved upwards on the display to accommodate the search results layer 510 while still showing the video chat layer 410 underneath the search results layer 510 and the chat layer 440.

FIG. 5 shows the discovery of content within live video chat allowing a user to select content real-time and share with others. Users are able to filter content while in the video screen without having to navigate to different apps on phone. For example, a use can filter based on location, ratings, cost, etc.

FIG. 6 illustrates the overlay of planning data search results and their selection on a video chat on a user device, according to one or more embodiments herein. The selection interface 610 is displayed on the device after the device receives an input from a user. The device may then receive confirmation via interface object 612 or rejection via interface object 614. If sharing is confirmed, then the planning data, for example, search result 520a, is shared with other devices that are participating in the video chat.

FIG. 6 also shows how after a planning data is shared within video chat, any user has the option to add that planning data to the plan, such as an meeting plan, a travel plan, or other type of activity plan, for example. A plan may be a collection of one or more places, activities, events, locations or media associated with one or more individuals. Each plan may or may not include a time. A plan can happen at a physical location or could occur online. Example of different types of plans include a plan including a movie and dinner or a plan to watch video programming (Movie, TV, Cable) within the video chat.

FIG. 7 illustrates the overlay of planning data in a planning view layer 710 on a video chat 410 on a user device 700, according to one or more embodiments herein. After a user device registers on the realtime database and video server, the user device displays a video view layer on the respective user device's screen. Each device that is registered with the realtime database and video server communicates by sending and receiving video and audio data to and from the server.

If a device participating in the video chat shares planning data, for example, the restaurant planning data shown and described with respect to FIG. 6, the device sends the planning data to the real time database server where it may be saved. Other participants in the video chat receive notification of the new planning data. Each device displays this planning data in a planning view layer 710 on top of the video view layer 410. The planning view layer 710 may be a rectangle that partially covers the video view layer. The planning view layer may not fully cover the video view layer, because user devices display the video view layer and planning view layer on the display at the same time.

The user device or server monitors for any changes in planning data (for example additional planning data shared from each user device participating in the video chat) on the realtime database. When changes are observed, the planning view layer updates. In some embodiments, the realtime database server sends a notification to the user device about new planning data changes on the realtime database. In some embodiments, the user device indicates to the realtime database information indicating that the user device has removed the planning view data from the display. In such cases, a notification is sent to the other user devices, for example, though the realtime database server, indicating the device's planning view layer is closed. The planning data that may have been shared with other user devices may then be removed from the planning view layer on the display of each other participating devices' display.

Each time new planning data is viewed on and/or shared from one user device, the user device sends a message to the realtime database server which is then sent to each other participating device so that each device may display the planning data. The message may include the planning data for display on each device's display.

The devices may receive votes to determine whether a particular piece of planning data is added to the plan. FIG. 8 illustrates the overlay of a plan 820 in a plan layer 810 on a video view layer on a user device 800, according to one or more embodiments herein. FIG. 8 shows an example of a plan that was created in video chat. This screen shows planning data, in this embodiment, a restaurant, that were added to a plan via live video chat. Users are able to navigate back into video chat and make real-time edits to the plan.

In FIG. 7, the planning view layer 710 may include an interface 716 for receiving input from each participating user to indicate a desire to add the planning data to the plan. Each device sends their vote to the realtime database where the votes are tallied and if the shared planning data receives a threshold amount of votes, such as at least half the number of votes as participants in the video chat, then the shared planning data is added to the plan 820 within the realtime database.

Each device displays this plan 820 within the plan view layer on top of the video view layer. The plan view layer may be a rectangle that partially covers the video view layer. The plan view layer may not fully cover the video view layer, because user devices display the video view layer and plan view layer on the display at the same time.

The user device or server monitors for any changes in plan data 820 on the realtime database, for example as a result of voting on planning data. When changes are observed, the plan view layer 810 updates. In some embodiments, the realtime database server sends a notification to the user device about new plan data changes on the realtime database. In some embodiments, the user device indicates to the realtime database information indicating that the user device has removed the plan data from the display, for example when a revote is taken for a piece of plan data and the vote results in removal of the plan data 820. In such cases, a notification is sent to the other user devices, for example, though the realtime database server, indicating the plan has changed. The plan data that may have been shared with other user devices may then be removed from the plan view layer on the display of each other participating devices' display.

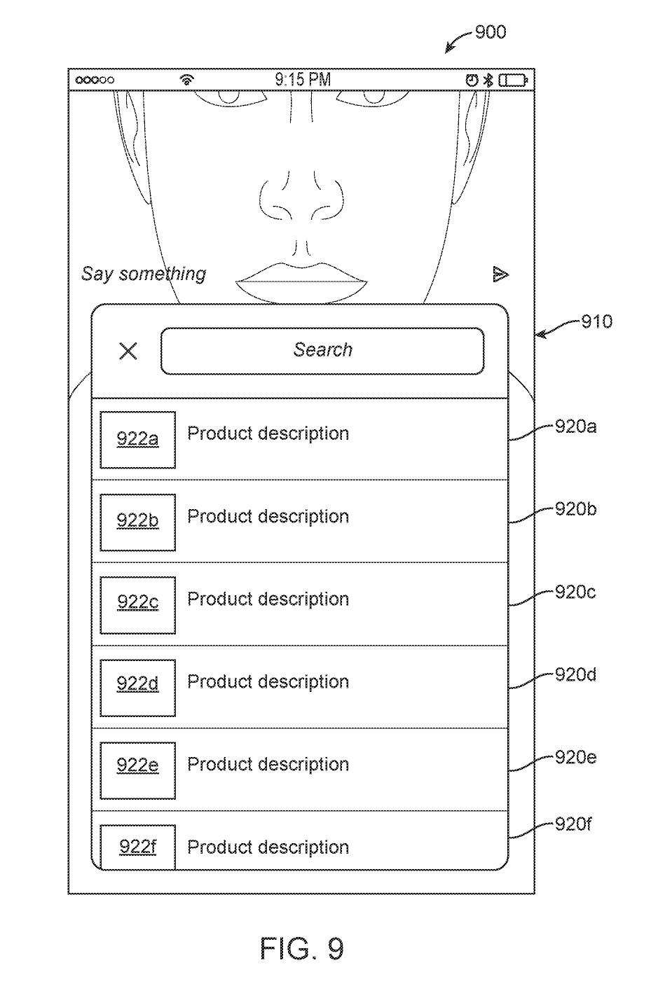

FIG. 9 illustrates the overlay of planning data search results 920 on a video chat on a user device 900, according to one or more embodiments herein. Similar to FIG. 5, above, during a search the user device 900 sends a request to the search server. The search server searches various sites to gather planning data search results 920 and sends the search results to the user device. The user device displays the search result planning data, such as product descriptions returned as a result of a product search, on a search result view layer 910 on top of the video view layer. The search result view layer 910 may be a rectangle that partially covers the video view layer. The search result view layer 910 may not fully cover the video view layer, because user devices display the video view layer and search result view layer 910 on the display at the same time. The search results view area may include a list of search results 920. Each search result may include data about the search result. For example, the search results displayed in FIG. 5, include results related to a product search. Accordingly, the search results 920 include data such as the product description of each product and an image 922 of the product. The search results data may also include other qualities of the results, such pricing, local or online retail stores from which you can purchase the product, etc.

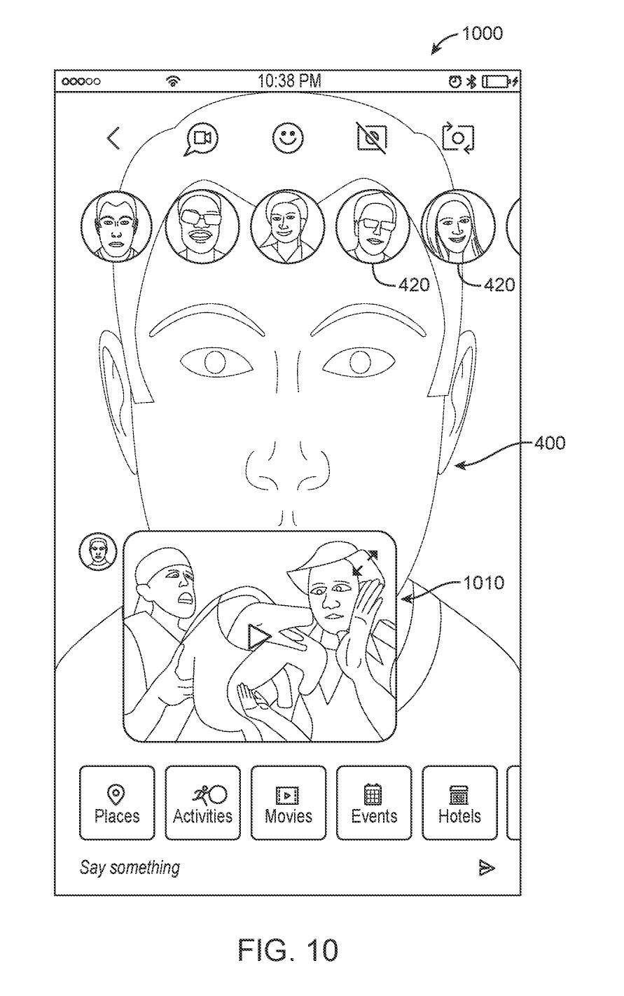

FIG. 10 illustrates the overlay of video planning data on a video chat on a user device, according to one or more embodiments herein. The video planning data may be a live or prerecorded video stream that is streamed to each device 1000 in a video player layer 1010. The user device displays the video data, such as a movie, TV, show, or other streamed video, on a video player layer 1010 on top of the video view layer 400. The search video player layer 1010 may be a rectangle that partially covers the video view layer. The video player layer 1010 may not fully cover the video view layer, because user should display the video view layer and search result view layer 1010 on the display at the same time.

One of the many advantages of the systems and methods disclosed herein is that multiple users and devices can to connect via video chat and view layers of event planning data in order to make plans. Users and user devices are able to share local listing data, movies, events, concerts, restaurants, coupons, and live video programming like movies and concerts. Users and user devices can share what they are interested in real-time with other devices and create an itinerary of the plan that is agreed upon by each user. The itinerary can then be shared with each device and updated in real-time.

While participating in a video chat, multiple activities are conducted and displayed on a user device screen simultaneously in layers. The activities may be related to the members of the video chat or the topic of the video chat, but do not have to be. Some activities include, conducting text chats with the members of the video chat as a group and also with a subset of the members of the video chat or with users who are not members of the video chat as shown in FIG. 7. The members of the video chat will be able to view only those group text chats where all members of the video chat are participants.

Watching streaming video with members of the video chat as a group, as shown in FIG. 10. An example of this would be watching a movie trailer. After watching a movie trailer the user could purchase movie tickets via their devices without leaving the video chat experience. The video chat continues, with each member of the video chat being visible to all other members, while each member of the video chat simultaneously watches the streamed video. Members of the video chat can talk, though their devices and the servers, over the audio of the streaming video. Members of the video chat can engage in text chats about the streaming video as a group while watching the video. Any member of the video chat can pause and re-start the streaming video. When a video is paused on one device it may be paused on all devices.

Plans may also be made with specific activities or events, specific sequences of activities or events, and specific times and locations for the activities or events. The end result is the creation of a plan that can be shared with others inside of the Video Chat UI. Any user can view, add to or delete any portion of the plan. All members of the video chat are added as plan participants, but the members of the video chat can add or delete plan participants so that the plan participants can become all or a subset of the members of the video chat plus users who are not members of the video chat. All members of the video chat plus all other plan participants immediately and simultaneously are be able to view all actions taken with respect to the plan by any plan participant. So actions taken by plan participants who are not members of the video chat are visible to all members of the video chat, and vice versa.

During the process, plan participants may vote on whether they like or do not like specific events or activities as a group. This vote is recorded and displayed to the plan participants and members of the video chat within the plan. Each plan participant may re-order the sequence of activities or events in the plan. Each plan participant may edit the timing of the each of the activities or events in the plan. Each plan participant may add activities or events to the plan or delete activities or events from the plan.

Users are able to use all of the functionality of the system while on a video chat and do so in a way that all or none of the actions that they take are visible to the members of the video chat. These actions include conducting a text chat, creating a plan involving participant who are not members of the video chat, conducting transactions such as buying movie tickets, making reservations at a restaurant, making a purchase at a business, and more.

Members of the video chat can add users to the video chat. The newly-added users have access to the history of the video chat—any text chats, the contents of plans created as part of the video chat (whether or not the newly-added member of the video chat is a plan participant), a record of any videos that the members of the video chat watched, and a record of any users who were added to or removed from the video chat.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for overlaying planning items over a video on a display comprising:
sending, by a first user device of a plurality of user devices to a second user device of a plurality of user devices, a request to join a video chat;
sending, by the second user device, a confirmation to join the video chat;
displaying, on the first device a video chat layer;
overlaying, over the video chat layer, a data layer; and
displaying simultaneously the video chat in the video chat layer and data in the data layer.

2. The method of claim 1, wherein:
the data layer is a planning data layer and the data displayed in the planning layer is planning data.

3. The method of claim 2, wherein:
the planning data is one or more of local listing data, movies, events, concerts, restaurants, coupons, and live video programming.

4. The method of claim 1, further comprising:
receiving, on the second device, video and audio from the first device; and
displaying the video from the first device in the video chat layer.

5. The method of claim 1, further comprising:
sending, from the first device to a realtime database, planning data.

6. The method of claim 5, further comprising:
receiving, on the second device, an indication of the receipt of the planning data on the realtime database.

7. The method of claim 6, further comprising:
updating the data in the data layer to include the planning data sent to the realtime database; and
displaying the planning data in the data layer.

8. The method of claim 7, further comprising:
receiving, by the realtime database, votes regarding the planning data from the plurality of user devices;
adding the planning data to a plan, if the number of votes is greater than a threshold number of votes.

9. The method of claim 2, further comprising:
displaying on the display, a text chat layer over the video chat layer; and
displaying, simultaneously, video chat data on the video chat layer, planning data on the planning data layer, and text chat data on the text chat layer.

10. The method of claim 1, further comprising:
a movie data layer and the data displayed in the planning layer a movie.

11. A system for overlaying planning items over a video on a display of a first user device comprising:
a display;
a processor; and
a memory comprising a program code, that when executed by the processor cause the processor to:
send, to second user device, a request to join a video chat;
receive, by the first user device, a confirmation to join the video chat;
display, on the first device a video chat layer;
overlay, over the video chat layer, a data layer; and
display simultaneously the video chat in the video chat layer and data in the data layer.

12. The system of claim 11, wherein:
the data layer is a planning data layer and the data displayed in the planning layer is planning data.

13. The system of claim 12, wherein:
the planning data is one or more of local listing data, movies, events, concerts, restaurants, coupons, and live video programming.

14. The system of claim 11, wherein the program, when executed, causes the processor to:
Receive video and audio from the second device; and
display the video from the second device in the video chat layer.

15. The system of claim 11, wherein the program, when executed, causes the processor to:
receive, from a realtime database server, an indication of the receipt of updated planning data at the realtime database.

16. The system of claim 15, wherein the program, when executed, causes the processor to:
updating the data in the data layer to include the updated planning data at the realtime database; and
displaying the updated planning data in the data layer.

17. The system of claim 16, wherein the program, when executed, causes the processor to:
send, to the realtime database, votes regarding the planning data from the plurality of user devices;
display, in a plan layer over the video chat layer, the planning data, if the planning data was added to the plan.

18. The system of claim 12, wherein the program, when executed, causes the processor to:
display on the display, a text chat layer over the video chat layer; and
display, simultaneously, video chat data on the video chat layer, planning data on the planning data layer, and text chat data on the text chat layer.

19. The system of claim 11, wherein the program, when executed, causes the processor to:
display a movie data layer over the video chat layer; and
play a move in the data layer.
